(19) United States
(12) Patent Application Publication
(10) Pub. No.: US 2007/0166569 A1
(43) Pub. Date: Jul. 19, 2007

(54) Electrophoretic dip painting installation

(76) Inventors: Hans Kaspar Von Kaphengst, Dettenhausen (DE); Wemer Mai, Weil im Schoenbuch (DE); Bernd Raabe, Kranichfeld (DE); Marco Ebbinghaus, Solingen (DE)

Correspondence Address: FACTOR & LAKE, LTD, 1327 W. WASHINGTON BLVD., SUITE 5G/H, CHICAGO, IL, 60607, US

(21) Appl. No.: 10/559,482

(22) PCT Filed: Jun. 2, 2004
(86) PCT No.: PCT/EP04/05926

§ 371 Date: Nov. 13, 2006

(30) Foreign Application Priority Data
Jun. 6, 2003 (DE) 103 25 656.3

(51) Int. Cl. B32B 9/00; B32B 19/00

(52) U.S. Cl. 428/698

(57) ABSTRACT

The invention relates to an electrophoretic dipping system comprising at least one bowl (1) which can be filled with a liquid and an object which is to be coated and which can be dipped therein. At least one power supply unit (5A, 5B, 5C) produces DC voltage with definite residual ripple from AC voltage. The one pole thereof can be connected to at least one electrode of a first polarity (3A, 3B, 3C), said electrode being arranged in the dipping bowl (1) and the other pole thereof can be connected to the object which is to be coated. The power supply unit (5A, 5B, 5C) comprises one uncontrolled diode rectifler bridge (19) and an IGBT switch (22) which comprises a controllable oscillator (24) and a power transistor (23). The controllable oscillator (24) generates pulses having a repetition frequency ranging from between 5 and 30 kHz with variable pulse widths. The power transistor (23) is controlled by said pulses. The voltage pulses produced therefrom can be smoothed out with the aid of relatively small smoothing elements until a highly reduced residual ripple which benefits the quality, especially the smoothness and the roughness of the applied protective coating is obtained. Said power supply unit (5A, 5B, 5C) also has a highly improved cos Φ compared to currently known thyristor bridge switches used for the same purpose.

The invention relates to an electrophoretic dip painting installation, comprising:
a) at least one dip paint bath that can be filled with a paint liquid and into which an object to be painted can be dipped;
b) at least one electrode having a first polarity arranged in the dip paint bath;
c) at least one power supply unit which generates from an alternating voltage a direct voltage having a given residual ripple, one pole of which power supply unit is connectable to the electrode having the first polarity and the other pole of which is connectable to the object to be painted, and which includes a smoothing element for reducing the residual ripple.

Such electrophoretic, generally cataphoretic, dip painting installations are commercially known. They must be able to deliver a smoothed direct voltage the level of which is variable for adaptation to the given circumstances. Only in very few cases is the maximum possible direct voltage required from the power supply units over a relatively long period. The cases in which a direct voltage reduced with respect to the maximum level is required are far more frequent, and the time periods concerned are far longer. To generate the direct voltage, the known power supply units have thyristor bridge circuits. These are activated using a phase control method in such a way that, after smoothing, the required level of direct voltage is established. Various disadvantages are associated with this method. Firstly, the output voltage generated directly by the thyristor bridge circuit has very high ripple, which has the frequency of the alternating voltage from which it has been generated. The smoothing elements needed to smooth this voltage require very large smoothing chokes which are not only expensive but very heavy and have a large space requirement. Despite the use of such expensive smoothing elements, in the known cataphoretic dip painting installations a not inconsiderable residual ripple remains in the voltage between the anode and the objects to be painted, which has a detrimental effect on the paint finish achieved. In addition, the stability of the dialysis cells which generally surround the anodes arranged in the dip paint bath is impaired. Furthermore, the cos Φ of these known power supply units is comparatively low.

It is the object of the present invention so to configure an electrophoretic dip painting installation of the type mentioned in the introduction that the output voltage of the power supply unit has low residual ripple, using circuit technology of low cost and complexity.

This object is achieved according to the invention in that
d) the power supply unit comprises:
   da) an uncontrolled diode rectifier bridge;
   db) an IGBT circuit which in turn includes a controllable oscillator which generates pulses having a repetition frequency in the range from 5 to 30 kHz and variable pulse width, and a power transistor activated by the pulses of the oscillator.

According to the invention, therefore, thyristor bridge circuits are no longer used to generate the required direct voltage. Instead, a circuit arrangement which is already used in a similar form in galvanising processes is employed. In the latter, of course, the voltages and power levels utilised are much lower than in the electrophoretic dip painting installations. The basic concept of current supply arrangements of this type is that of inducing pulse width modulation in the optionally pre-smoothed voltage generated by an uncontrolled diode rectifier bridge, said modulation having a comparatively high frequency far above mains frequency. The pulses generated in this way can be smoothed to a negligibly low residual ripple using comparatively small LC elements. The level of the smoothed output voltage of such power supply units is directly proportional to the duty factor of the voltage pulses emitted by the power transistor. The residual ripple of the smoothed voltage which establishes the electrical field between electrode and object required for electrophoretic painting is so low that a considerably superior paint finish, in particular a smoother surface, is produced. This is achieved with considerably reduced sizes of the smoothing chokes used. The lower residual ripple also has a positive effect on the service life of the dialysis cells.

The repetition frequency of the oscillator is preferably approximately 20 kHz. Power transistors can be operated without problems at this frequency; furthermore, the frequency is high enough for the smoothing of the rectangular pulses generated not to present any difficulties.

It is advantageous if the diode rectifier bridge includes six diodes for full-wave rectification of the three phases of a three-phase current.

In general, the objects to be painted are moved by means of a conveyor system to the dip paint bath, dipped therein, moved through the dip paint bath, raised therefrom and then moved onwards for further processing.

In this case a configuration of the invention is recommended in which a plurality of zones located one behind the other in the conveying direction, which zones are normally separated galvanically from one another and each of which includes a power supply unit, a current bar which is in electrical contact with the object in the zone in question and is connected to the one pole of the power supply unit, and at least one electrode having the first polarity. The subdivision of the total installation into successive zones which are electrically operable individually makes it possible to adapt the electrical fields locally to the progressive build-up of the paint layer on the objects—for example, to increase said fields in the conveying direction. Through the galvanic separation of the individual zones, undesired interactions in the transition regions can be avoided.

If, in such a case, the current bars of adjacent zones are electrically connectable to one another during the transfer of the objects from one current bar to the other, the voltage ratios always remain defined during this transfer of the objects.

The embodiment of the invention in which each power supply unit is optionally connectable to each electrode of the first polarity in all the zones is especially variable, especially in the event of a fault in one power supply unit. In this case, if a power supply unit fails because of a fault, at least emergency operation can be maintained with the aid of another power supply unit.

Substantially superior painting results, especially on the internal surfaces of hollow structures, can be achieved if a pulse shaper which generates a succession of rectangular pulses from the smoothed output voltage of the power supply unit is connected to the output of at least one power supply unit. In this way, the effect of electrically conductive hollow structures acting as Faraday cages can be largely eliminated, which effect would prevent static electrical fields from penetrating the interior.

It is advantageous if the repetition frequency of the rectangular pulses is from 1 to 10 kHz, preferably at or close to 5 kHz.

An embodiment of the invention is explained in more detail below with reference to the drawings, in which:

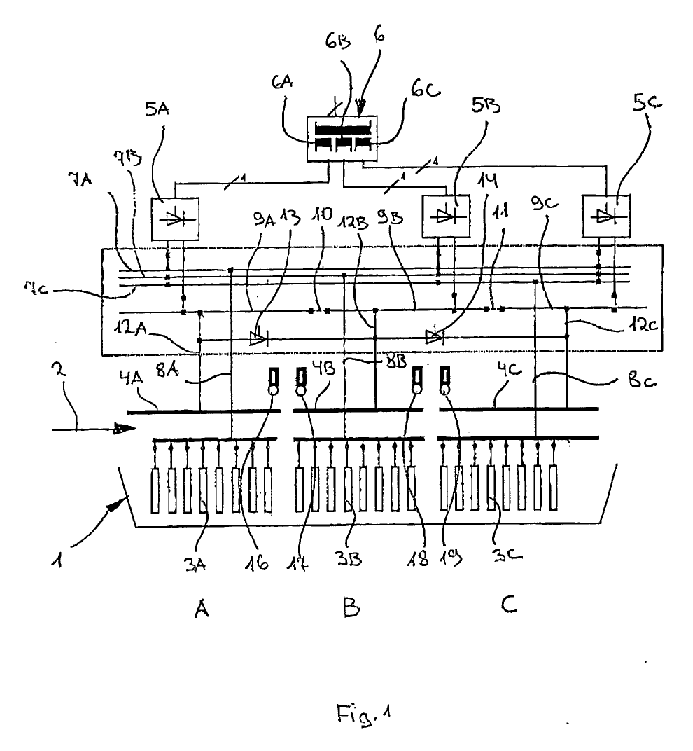

FIG. 1 shows schematically a total circuit arrangement for a cataphoretic dip painting installation;

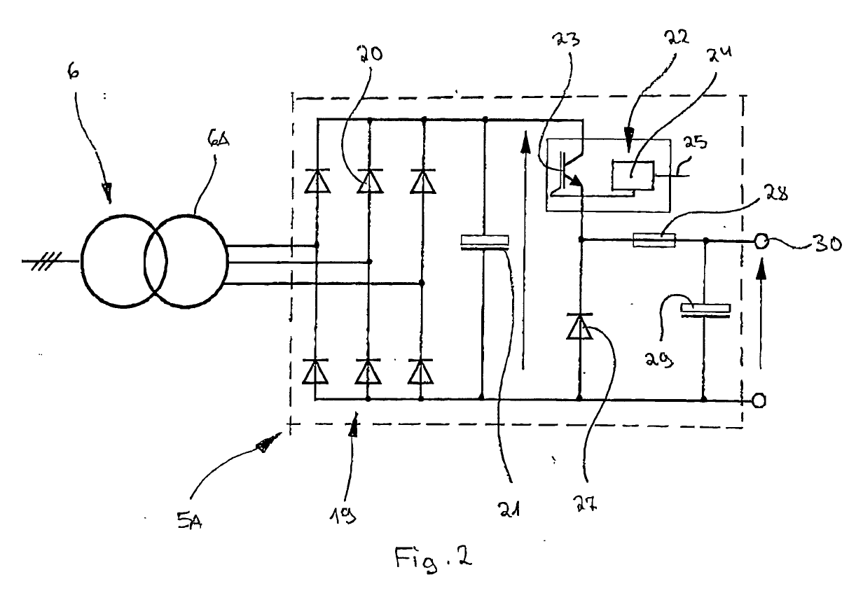

FIG. 2 shows the circuit diagram of a power supply unit as utilised in the installation of FIG. 1;

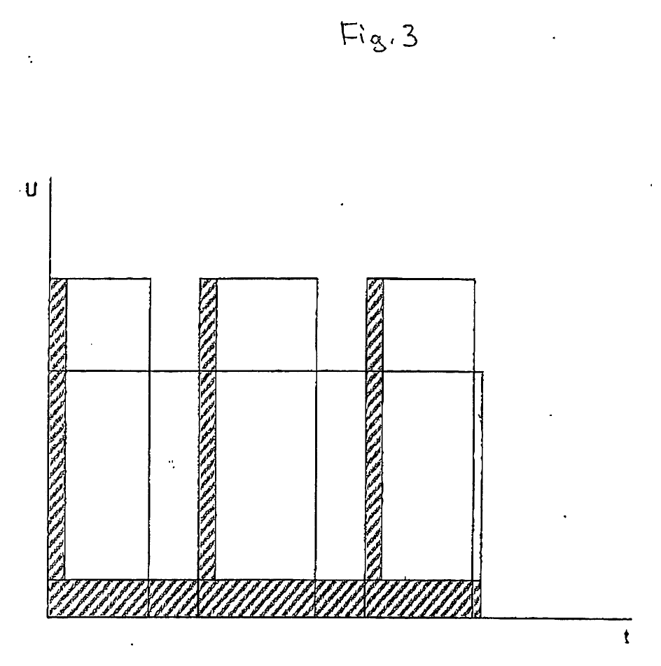

FIG. 3 shows a pulse sequence as emitted by the power supply unit of FIG. 2;

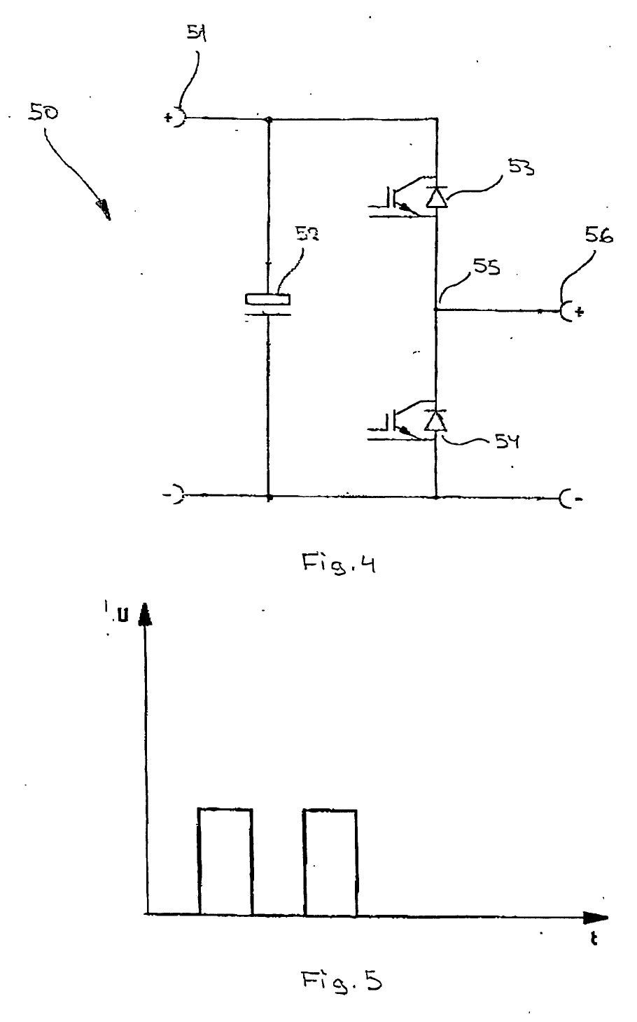

FIG. 4 shows a pulse shaper which may be connected to the output of the power supply unit represented in FIG. 2;

FIG. 5 shows a pulse sequence as emitted by the pulse shaper represented in FIG. 5.

Reference is first made to FIG. 1. In this Figure a dip paint bath which in operation is filled with a paint liquid is denoted by reference 1. The objects to be painted, for example, vehicle bodies, are dipped into this dip paint bath 1. This may take place either in a continuously moving process, for which the objects to be painted are attached to a conveyor which moves them into, through and out of the dip paint bath 1. Alternatively, however, it is possible to paint the objects in the dip paint bath 1 in a discontinuous dipping process. For the purposes of the following description a continuous process is assumed. The direction of movement of the objects to be painted is indicated by the arrow 2.

In order to deposit the paint particles, e.g. the pigment, medium and extender particles, contained in the paint liquid, the surfaces of the objects are placed under the cathode potential of an electrical field which is established between a multiplicity of anodes 3 and the surfaces of the objects as they pass through the dip paint bath 1. In this electrical field the paint particles migrate towards the objects and are deposited on their surfaces.

The total arrangement with which the above-mentioned electrical field is generated in the dip paint bath 1 is subdivided into three galvanically separated zones A, B and C. Zone A is an entrance zone, zone B is a main zone and zone C is an exit zone. Each zone A, B, C includes a group of anodes 3A, 3B and 3C, each connected in parallel and arranged adjacently to the movement path of the objects. In addition, each zone A, B, C has a current bar 4A, 4B, 4C which carries cathode potential and with which the objects are permanently in contact through a suitable sliding contact. Finally each zone A, B, C has its own associated power supply unit 5A, 5B, 5C, the negative pole of which is connected to the current bar 4A, 4B, 4C and finally, via the latter, to the object be painted and its positive pole, with the respective groups of anodes 3A, 3B, 3C. The three power supply units 5A, 5B, 5C are each fed by a secondary coil 6A, 6B, 6C of a three-phase transformer 6.

The connection between the power supply units 5A, 5B, 5C and the anode groups 3A, 3B, 3C is effected via a group of three lines 7A, 7B, 7C which extend the full length of the dip paint bath 1. Each power supply unit 5A, 5B, 5C can be connected optionally to each line 7A, 7B, 7C. However, the normal operating state is that power supply unit 5A is connected to line 7A, power supply unit 5B to line 7B and power supply unit 5C to line 7C.

Line 7A is connected via a branch line 8A to anode group 3A, line 7B via a branch line 8B to anode group 3B and line 7C via a branch line 8C to anode group 3C. The arrangement is therefore such that if required, for example, during emergency operation after the failure of a power supply unit 5A, 5B or 5C, each anode group 3A, 3B, 3C can be supplied with anode voltage from each power supply unit 5A, 5B, 5C.

The positive pole of each power supply unit 5A, 5B, 5C can be connected to a respective associated line section 9A, 9B, 9C which extends along the movement direction (arrow 2) of the objects. Normally, the line sections 9A, 9B, 9C are separated galvanically from one another. However, they can be connected to one another if required by means of switches 10, 11. Branch lines 12A, 12B, 12C run from the respective line sections 9A, 9B, 9C to the corresponding current bars 4A, 4B, 4C. It is therefore the case that the current bars 4A, 4B, 4C can also optionally be energised by each of the power supply units 5A, 5B, 5C, but that normally power supply unit 5A is allocated to current bar 4A, power supply unit 5B to current bar 4B and power supply unit 5C to current bar 4C.

The branch lines 12A and 12B are connected to one another via a controllable thyristor 13, and the branch lines 12B and 12C via a controllable thyristor 14. The thyristors 13, 14 are normally blocked, so that the galvanic separation between the current bars 4A, 4B and 4C is maintained.

Presence sensors 16, 17, 18, 19 are arranged along the movement path of the objects in the vicinity of the interruptions which separate the current bars 4A and 4B and the current bars 4B and 4C from one another. These sensors detect when an object is at the location in question and trigger a signal to activate the thyristors 13, 14, as is described in more detail below.

The operation of the above-described dip painting installation is as follows:

In normal operation objects which are to be painted in the dip paint bath 1 approach in the direction of the arrow 2 and are dipped in said bath. By means of suitable contacting arrangements they are first connected to the current bar 4A and move in the paint liquid into the electrical field being established between the anode group 3A and their surfaces. The deposition of paint particles on the surfaces of the objects begins. As the object nears the end of the anode group 3A and therefore comes within detection range of the presence sensor 16, the thyristor 13 which connects the two current bars 4A and 4B becomes conductive. When the object reaches the detection range of the presence sensor 17 the thyristor 13 is blocked again. The two current bars 4A and 4B are therefore switched to the same potential only during the transition of the objects from current bar 4A to current bar 4B.

The object now moves through the paint liquid in the electrical field which is established between the current bar 4B, and therefore its surface, on one side, and the anode group 3B. In general, this electrical field is greater than that in the entrance zone A. In this main zone B the major part of the thickness of the paint layer is deposited on the surfaces of the object. When the object reaches the presence sensor 18, the thyristor 14 becomes conductive, so that the current bars 4B and 4C are connected to one another. This connection is maintained until the object has reached the detection range of the presence sensor 19 and is then interrupted again. In the exit zone C the electrical field is in general again somewhat greater than in the preceding zones A, B, the thickness of the paint layer deposited on the objects being raised to its final value. The objects then leave the dip paint bath 1 and are further processed in known fashion.

If, for example, the power supply unit 5A fails, emergency operation can be maintained in that one of the other power supply units 5B, 5C takes over the function of the failed power supply unit 5A. To achieve this, the power supply unit 5A is disconnected from the line 7A and from the line section 9A. An (additional) connection is established between, for example, the power supply unit 5B and the line 7A. At the same time the switch 10 is closed. In this way zones A and B are operated electrically in parallel. This can take place until the power supply unit 5A has been repaired.

All the power supply units 5A, 5B and 5C are in principle constructed in the same way. The circuit arrangement of the power supply unit 5A is represented in FIG. 2, to which reference is now made.

In FIG. 2 the three-phase transformer 6 to which mains voltage is supplied, and the secondary winding 6A associated with the power supply unit 5A, can be seen. The three voltage phases, each shifted by 120°, generated by the secondary winding 6A are supplied to an uncontrolled bridge circuit 19 which, as illustrated, includes six diodes 20. A capacitor 21, which pre-smoothes the output voltage of the bridge circuit 19, is connected in parallel to the output of the bridge circuit 19.

This output voltage is supplied to an IGBT circuit 22 which is known per se. This circuit includes at least one controllable power transistor 23 and an oscillator 24, which generates rectangular pulses of comparatively high frequency, having, for example, a repetition frequency of 20 kHz. The width of the rectangular pulses, and therefore the pulse duty factor, is variable via a control connection 25 of the oscillator 24. The rectangular pulses of the oscillator 24 are supplied to the control input of the power transistor 23.

The emitter of the power transistor 23 is connected to earth via a diode 27 connected in the reverse direction. At this diode 27 the output voltage of the IGBT circuit 22 drops. This output voltage has the time behaviour represented in FIG. 3. It consists of rectangular pulses the repetition frequency of which corresponds to that of the oscillator 24 of the IGBT circuit 22 and the width of which can be changed via the control connection 25 of the IGBT circuit. The amplitude of these voltage pulses is determined by the input voltage of the transformer 6 and by the design of the secondary winding 6A.

The output pulses of the IGBT circuit 22 represented in FIG. 3 are smoothed by an LC element which includes a choke 28 and a capacitor 29. The LC element is attuned to the repetition frequency of the oscillator 24 and therefore to the output pulses of the IGBT circuit 22. Because the repetition frequency of these output pulses, as mentioned above, is comparatively high, very good smoothing can be achieved with comparatively small chokes 28 and small capacitances 29. The output voltage of the power supply unit 5A which appears at the terminals 30 is therefore very largely free of residual ripple; the latter can be suppressed below approximately 1% without difficulty. In addition, the cos Φ of the power supply unit 5A described is far lower than was the case with known power supply units operating with controllable thyristor bridges. The result is a superior coating result with less surface roughness.

In FIG. 3 two exemplary pulse sequences having different pulse widths are represented as they are applied to the diode 27, together with the associated smoothed voltages as they appear at the terminals 30 of the circuit arrangement of FIG. 2.

The power supply units 5A, 5B, 5C may operate both in a current-controlled and in a voltage-controlled manner.

Better painting result than known hitherto are achieved in hollow structures if the output voltage of the power supply units 5A, 5B and 5C is not applied directly to the object to be painted, but initially to a pulse shaper 50, as represented in FIG. 4. The pulse shaper 50 generates from the smoothed output voltage at the terminals 30 of the power supply unit 5A, 5B or 5C a rectangular pulse sequence with a repetition frequency which is normally in the range from 1 to 10 kHz, preferably at or close to 5 kHz.

The pulse shaper 50 represented in FIG. 4 is known in principle. It comprises a capacitor 52 connected in parallel to the input 51, and two serially-connected IGBT transistors 53 and 54, in turn connected in parallel to the capacitor 52, which are activated in the reverse direction with the desired frequency of the rectangular pulse sequence. These rectangular pulses can be tapped at the point 55 between the two IGBT transistors 53, 54, and appear at the output terminals of the pulse shaper 50 in the form represented in FIG. 5.

When the pulse shaper 50 is used, the associated power supply unit 5A, 5B, 5C is as a rule current-controlled, although voltage is limited to a maximum value in order to avoid voltage arc-over on the workpiece.

1. An electrophoretic dip painting installation, comprising:
at least one dip painting bath which can be filled with a paint liquid and in which an object to be painted can be dipped;
at least one electrode having a first polarity arranged in the dip paint bath; and
at least one power supply unit which generates from an alternating voltage a direct voltage having a given residual ripple, one pole of which power supply unit is connectable to the electrode having the first polarity and the other pole of which is connectable to the object to be painted, and which includes a smoothing element for reducing the residual ripple, wherein
the power supply unit includes:
an uncontrolled diode rectifier bridge;
an IGBT circuit which in turn includes a controllable oscillator which, with a repetition frequency in the range from 5 to 30 kHz, generates pulses of variable width, and a power transistor activated by the pulses of the oscillator.

2. The electrophoretic dip painting installation of claim 1, wherein the repetition frequency of the oscillator is approximately 20 kHz.

3. The electrophoretic dip painting installation according to claim 1, wherein the diode rectifier bridge includes six diodes for full-wave rectification of the three phases of a three-phase current.

4. The electrophoretic dip painting installation of claim 1, in which the objects can be moved through the dip paint bath by means of a conveyor system including, a plurality of zones located one behind another in the conveying direction and normally separated galvanically from one another, each of which includes a power supply unit, a current bar which is in electrical contact with the objects in the plurality of zones and is connectable to the other pole of the power supply unit, and at least one electrode having the first polarity.

5. The electrophoretic dip painting installation of claim 4, wherein the current bars of neighbouring zones are electrically connectable to one another during the transfer of the objects from one current bar to the other.

6. The electrophoretic dip painting installation of claim 4, wherein each power supply unit is optionally connectable to each electrode having the first polarity in all the zones.

7. The electrophoretic dip painting installation of claim 1, wherein a pulse shaper is connected to the output of at least one power supply unit, which pulse shapers generates a succession of rectangular pulses from the smoothed output voltage of the power supply unit.

8. The electrophoretic dip painting installation of claim 7, wherein the repetition frequency of the rectangular pulses is between 1 and 10 kHz.

9. The electrophoretic dip painting installation of claim 8, wherein the repetition frequency of the rectangular pulses is at or close to 5 kHz.

10. The electrophoretic dip painting installation according to claim 2, wherein the diode rectifier bridge includes six diodes for full-wave rectification of the three phases of a three-phase current.

11. The electrophoretic dip painting installation of claim 10, in which the objects can be moved through the dip paint bath by means of a conveyor system including a plurality of zones located one behind another in the conveying direction and normally separated galvanically from one another, each of which includes a power supply unit, a current bar which is in electrical contact with the objects in the plurality of zones- and is connectable to the other pole of the power supply unit, and at least one electrode having the first polarity.

12. The electrophoretic dip painting installation of claim 11, wherein the current bars of neighbouring zones are electrically connectable to one another during the transfer of the objects from one current bar to the other.

13. The electrophoretic dip painting installation of claim 12, wherein each power supply unit is optionally connectable to each electrode having the first polarity in all the zones.

14. The electrophoretic dip painting installation of claim 13, wherein a pulse shaper is connected to the output of at least one power supply unit, which pulse shaper generates a succession of rectangular pulses from the smoothed output voltage of the power supply unit.

15. The electrophoretic dip painting installation of claim 14, wherein the repetition frequency of the rectangular pulses is between 1 and 10 kHz.

16. The electrophoretic dip painting installation of claim 15, wherein the repetition frequency of the rectangular pulses is at or close to 5 kHz.

17. The electrophoretic dip painting installation of claim 2, in which the objects can be moved through the dip paint bath by means of a conveyor system including a plurality of zones located one behind another in the conveying direction and normally separated galvanically from one another, each of which includes a power supply unit, a current bar which is in electrical contact with the objects in the plurality of zones- and is connectable to the other pole of the power supply unit, and at least one electrode having the first polarity.

18. The electrophoretic dip painting installation of claim 17, wherein the current bars of neighbouring zones are electrically connectable to one another during the transfer of the objects from one current bar to the other.

19. The electrophoretic dip painting installation of claim 18, wherein each power supply unit is optionally connectable to each electrode having the first polarity in all the zones.

20. The electrophoretic dip painting installation of claim 19, wherein a pulse shaper is connected to the output of at least one power supply unit, which pulse shaper generates a succession of rectangular pulses from the smoothed output voltage of the power supply unit.
